(19) United States
(12) Patent Application Publication
(10) Pub. No.: US 2018/0025740 A1
(43) Pub. Date: Jan. 25, 2018

(54) OPTIMIZATION OF SPEECH INPUT FOR MULTIPLE SPEECH AGENTS USED IN A COMMON APPLICATION ENVIRONMENT

(71) Applicant: Panasonic Automotive Systems Company of America, Division of Panasonic Corporation of North America, PEACHTREE CITY, GA (US)

(72) Inventor: MICHAEL T. BURK, TYRONE, GA (US)

(73) Assignee: Panasonic Automotive Systems Company of America, Division of Panasonic Corporation of North America

(21) Appl. No.: 15/652,970

(22) Filed: Jul. 18, 2017

Related U.S. Application Data
(60) Provisional application No. 62/365,025, filed on Jul. 21, 2016.

(51) Int. Cl. G10L 21/02; G10L 21/0232; G10L 25/18; G10L 15/22

(52) U.S. Cl. CPC G10L 21/0205; G10L 15/22; G10L 21/0232; G10L 25/18; G10L 2021/02082

(57) ABSTRACT

An automotive speech input optimization method includes using a microphone to convert audible speech into an audio signal. A selection of a speech agent is received. Spectral matching is performed on the audio signal to produce a conditioned audio signal. The spectral matching is dependent upon the selection of the speech agent. The conditioned audio signal is input to the selected speech agent.

### CROSS-REFERENCED TO RELATED APPLICATIONS

This application claims benefit of U.S. Provisional Application No. 62/365,025 filed on Jul. 21, 2016, which the disclosure of which is hereby incorporated by reference in its entirety for all purposes.

### FIELD OF THE INVENTION

The disclosure relates to the field of automotive speech recognition systems, and, more particularly, to the optimization of automotive speech recognition systems utilizing multiple speech agents.

### BACKGROUND OF THE INVENTION

It has become common that complex software based platforms (e.g., cell phones, in-vehicle infotainment systems, cloud agents, etc.) aggregate information sources from multiple agents, such as navigation agents, search agents (local and cloud based), OS specific applications, and Bluetooth profiles for hands free telephone operation. Often interaction with these multiple agents is via speech input. Each of these speech agents may be trained to optimally recognize speech input based on a clean input signal optimized for signal/noise performance, freedom from echoes, discrimination between the intended speaker and other background speech, etc. Additionally, the speech recognition engine is expecting a spectral match to the spectral characteristics of the speech training base used to create that particular speech agent. Improper alignment of any of these parameters results in a reduction of recognition accuracy. Where an application and/or system is traditionally built around a single speech agent and acoustic system, an application environment involving multiple speech agents at best will have parametric mismatches resulting in less than optimal performance.

### SUMMARY

The present invention may provide a spectral matching function specific to each speech agent, and which is invoked by the system application as each speech engine or agent is called upon for interaction. The optimization of the spectral content to the invoked speech agent may improve the recognition rate for that agent.

In one embodiment, the invention comprises an automotive speech input optimization method, including using a microphone to convert audible speech into an audio signal. A selection of a speech agent is received. Spectral matching is performed on the audio signal to produce a conditioned audio signal. The spectral matching is dependent upon the selection of the speech agent. The conditioned audio signal is input to the selected speech agent.

In another embodiment, the invention comprises an automotive speech input optimization arrangement including a microphone converting audible speech into an audio signal. A processing device is communicatively coupled to the microphone and receives a selection of a speech agent. The processing device performs spectral matching on the audio signal to produce a conditioned audio signal. The spectral matching is dependent upon the selection of the speech agent. The processing device transmits the conditioned audio signal to the selected speech agent.

In yet another embodiment, the invention comprises an automotive speech input optimization method, including using a microphone to convert audible speech into an audio signal. Signal conditioning, spatial filtering, echo cancellation and noise reduction are performed on the audio signal. A selection of a speech agent is received. Spectral matching is performed on the audio signal to produce a conditioned audio signal. The spectral matching is based on the selection of the speech agent. The conditioned audio signal is inputted to the selected speech agent.

### BRIEF DESCRIPTION OF THE DRAWINGS

A better understanding of the present invention will be had upon reference to the following description in conjunction with the accompanying drawings.

FIG. 1 is a block diagram of one embodiment of a speech input optimization arrangement of the present invention.

FIG. 2 is a flow chart of one embodiment of an automotive speech input optimization method of the present invention.

### DETAILED DESCRIPTION OF THE PREFERRED EMBODIMENTS

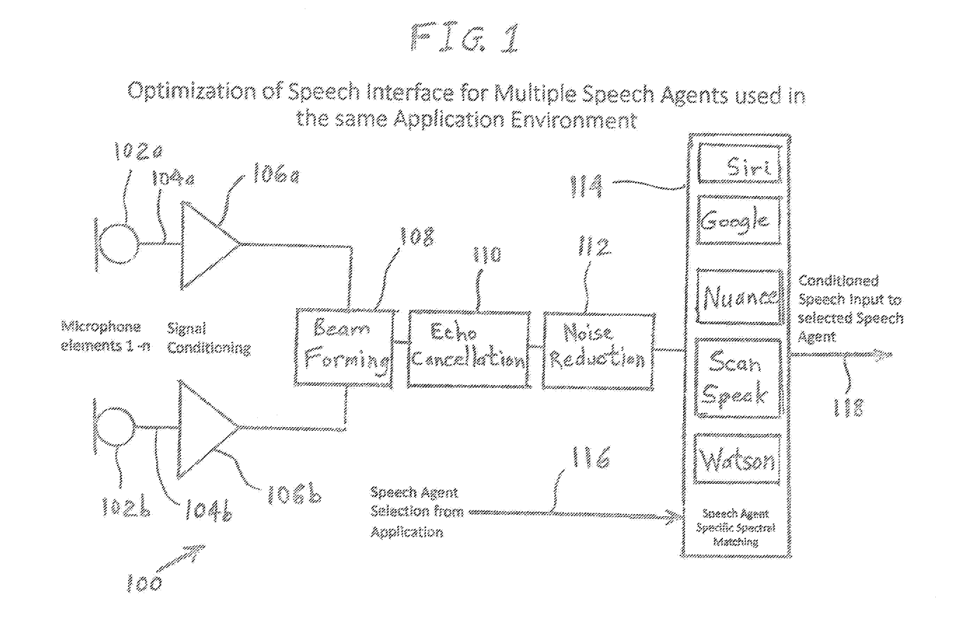

FIG. 1 illustrates one embodiment of a speech input optimization arrangement 100 of the present invention. Microphones 102a-b pick up audible speech within a passenger compartment of a motor vehicle and convert the audible speech into respective electrical audio signals 104a-b. Audio signals 104a-b undergo signal conditioning in respective signal conditioners 106a-b and signal processing in the form of spatial filtering or beamforming, as indicated at block 108. Thereafter, the audio signals may undergo echo cancellation in block 110 and noise reduction in block 112.

In block 114, spectral matching is performed on the audio signals, wherein the spectral matching is tailored for the particular speech agent that is to receive and operate on the audio signals. In the example embodiment shown, block 114 is capable of performing different spectral matching for each of five corresponding speech agents, including Siri, Google, Nuance, Scan Speak and Watson. As indicated at 116, the speech agent is selected by an application, and the selection is received by block 114. As indicated at 118, after the speech agent-specific spectral matching has been performed in block 114, the conditioned audio signals are input to the selected speech agent.

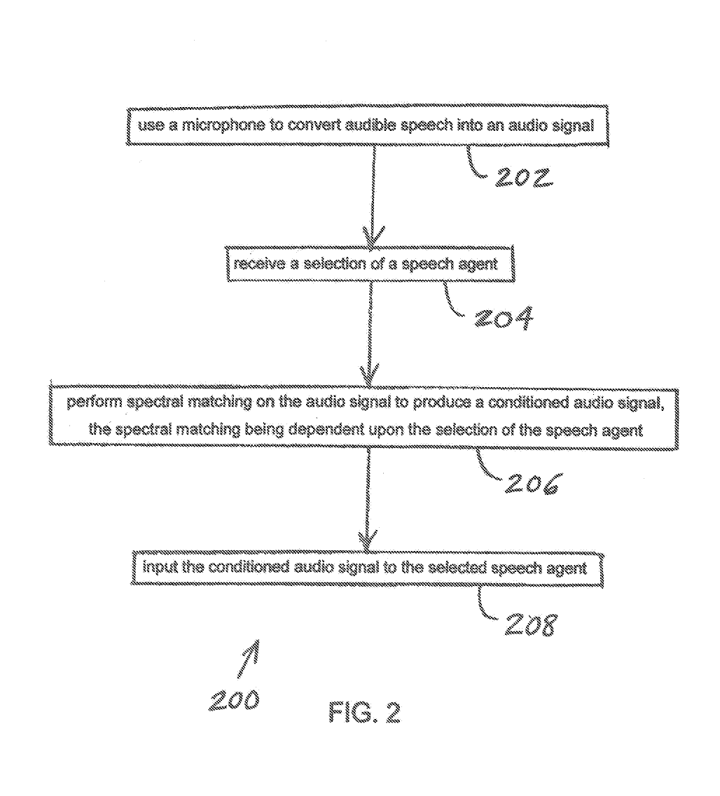

FIG. 2 illustrates one embodiment of an automotive speech input optimization method 200 of the present invention.

In a first step 202, a microphone is used to convert audible speech into an audio signal. For example, microphones 102a-b may pick up audible speech within a vehicle passenger compartment and convert the speech into audio signals 104a-b, respectively.

In a next step 204, a selection of a speech agent is received. For example, as indicated at 116, a speech agent, such as Siri, Google, Nuance, Scan Speak or Watson, may be selected by a computer application, and the selection may be received by block 114.

Next, in step 206, spectral matching is performed on the audio signal to produce a conditioned audio signal. The spectral matching is dependent upon the selection of the speech agent. For example, speech agent-specific spectral matching may be performed in block 114.

In a final step 208, the conditioned audio signal is input to the selected speech agent. For example, as indicated at 118, after the speech agent-specific spectral matching has been performed in block 114, the conditioned audio signals are input to the selected speech agent.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An automotive speech input optimization method, comprising the steps of:
using a microphone to convert audible speech into an audio signal;
receiving a selection of a speech agent;
performing spectral matching on the audio signal to produce a conditioned audio signal, the spectral matching being dependent upon the selection of the speech agent; and
inputting the conditioned audio signal to the selected speech agent.

2. The method of claim 1 wherein the microphone converts audible speech within a passenger compartment of a motor vehicle into the audio signal.

3. The method of claim 1 comprising the further step of performing signal conditioning on the audio signal before the spectral matching.

4. The method of claim 1 comprising the further step of performing beamforming on the audio signal before the spectral matching.

5. The method of claim 1 comprising the further step of performing echo cancellation on the audio signal before the spectral matching.

6. The method of claim 1 comprising the further step of performing noise reduction on the audio signal before the spectral matching.

7. The method of claim 1 wherein the selected speech agent comprises Siri, Google, Nuance, Scan Speak, or Watson.

8. The method of claim 1 wherein the spectral matching is performed specific to the selected speech agent.

9. The method of claim 1 wherein the spectral matching is initiated in response to the selected speech agent being called upon for interaction.

10. An automotive speech input optimization arrangement, comprising:
a microphone configured to convert audible speech into an audio signal;
a processing device communicatively coupled to the microphone and configured to:
receive a selection of a speech agent;
perform spectral matching on the audio signal to produce a conditioned audio signal, the spectral matching being dependent upon the selection of the speech agent; and
transmit the conditioned audio signal to the selected speech agent.

11. The arrangement of claim 10 wherein the microphone is configured to convert audible speech within a passenger compartment of a motor vehicle into the audio signal.

12. The arrangement of claim 10 wherein the processing device is configured to perform signal conditioning on the audio signal before the spectral matching.

13. The arrangement of claim 10 wherein the processing device is configured to perform beamforming on the audio signal before the spectral matching.

14. The arrangement of claim 10 wherein the processing device is configured to perform echo cancellation on the audio signal before the spectral matching.

15. The arrangement of claim 10 wherein the processing device is configured to perform noise reduction on the audio signal before the spectral matching.

16. The arrangement of claim 10 wherein the selected speech agent comprises Siri, Google, Nuance, Scan Speak, or Watson.

17. The arrangement of claim 10 wherein the processing device is configured to perform the spectral matching specific to the selected speech agent.

18. The arrangement of claim 10 wherein the processing device is configured to initiate the spectral matching after the selected speech agent has been called upon for interaction.

19. An automotive speech input optimization method, comprising the steps of:
using a microphone to convert audible speech into an audio signal;
performing signal conditioning on the audio signal;
performing spatial filtering on the audio signal;
performing echo cancellation on the audio signal;
performing noise reduction on the audio signal;
receiving a selection of a speech agent;
performing spectral matching on the audio signal to produce a conditioned audio signal, the spectral matching being based on the selection of the speech agent; and
inputting the conditioned audio signal to the selected speech agent.

20. The method of claim 19 wherein the microphone converts audible speech within a passenger compartment of a motor vehicle into the audio signal.

21. The method of claim 19 wherein the selected speech agent comprises Siri, Google, Nuance, Scan Speak, or Watson.

22. The method of claim 19 wherein the spectral matching is performed specific to the selected speech agent.

23. The method of claim 19 wherein the spectral matching is initiated in response to the selected speech agent being called upon for interaction.
